(19) United States
(12) Patent Application Publication
(10) Pub. No.: US 2023/0112933 A1
(43) Pub. Date: Apr. 13, 2023

(54) ELECTRONIC DEVICE

(71) Applicant: Guangdong Oppo Mobile Telecommunications Corp., LTD., Dongguan (CN)

(72) Inventors: Bin YIN, Dongguan (CN); Yongliang CHEN, Dongguan (CN)

(21) Appl. No.: 18/062,000

(22) Filed: Dec. 5, 2022

Related U.S. Application Data
(63) Continuation of application No. PCT/CN2021/091023, filed on Apr. 29, 2021.

(30) Foreign Application Priority Data
Jun. 28, 2020 (CN) 202010599851.8

(51) Int. Cl. G06F 1/16

(52) U.S. Cl. CPC G06F 1/1652; G06F 1/1624

(57) ABSTRACT

An electronic device is provided. The electronic device includes a first carrier, a second carrier, a first driving member, a second driving member, and a flexible screen assembly. The first driving member and the second driving member each are disposed on the second carrier. The flexible screen assembly has a first end and a second end each connected with the first carrier. The flexible screen assembly is wrapped around the first driving member and the second driving member. When the second carrier moves relative to the first carrier, the flexible screen assembly is configured to move relative to the first driving member and the second driving member.

### CROSS-REFERENCE TO RELATED APPLICATIONS

This application is a continuation of International Application No. PCT/CN2021/091023, filed Apr. 29, 2021, which claims priority to Chinese Patent Application No. 202010599851.8, filed Jun. 28, 2020, the entire disclosures of which are incorporated herein by reference.

### TECHNICAL FIELD

This disclosure relates to the field of electronic technology, and in particular to an electronic device.

### BACKGROUND

With development of electronic technology, display devices of electronic devices such as smart phones are becoming more and more intelligent. A display device of an electronic device can display a picture through a display screen of the display device.

A flexible display screen has attracted much attention due to folding and bending characteristics of the flexible display screen. By driving the flexible display screen to be extended outside the electronic device or retracted inside the electronic device, a screen display region of the electronic device can be adjusted, while the flexible display screen is easy to be damaged during movement.

### SUMMARY

An electronic device is provided in implementations of the present disclosure. The electronic device includes a first carrier, a second carrier, a first driving member, a second driving member, and a flexible screen assembly. The second carrier is movable relative to the first carrier. The first driving member and the second driving member each are disposed on the second carrier. The flexible screen assembly has a first end and a second end each connected with the first carrier. The flexible screen assembly is wrapped around the first driving member and the second driving member. A part of the flexible screen assembly located at the first driving member forms a first turn, and a part of the flexible screen assembly located at the second driving member forms a second turn. When the second carrier moves relative to the first carrier, the flexible screen assembly is configured to move relative to the first driving member and the second driving member. During extension of the electronic device, a part of the flexible screen assembly from the first end to the first turn becomes longer, and a part of the flexible screen assembly from the second turn to the second end becomes shorter.

An electronic device is provided in implementations of the present disclosure. The electronic device includes a first carrier, a second carrier, a first driving member, a second driving member, and a flexible screen assembly. The second carrier and the first carrier are movable relative to each other to make the electronic device extend. The first driving member and the second driving member each are disposed on the second carrier. The flexible screen assembly has a first end and a second end each connected with the first carrier. The flexible screen assembly is wrapped around the first driving member and the second driving member. A projection of the second end on a plane where the first carrier is located falls between a projection of the first driving member on the plane where the first carrier is located and a projection of the second driving member on the plane where the first carrier is located.

### BRIEF DESCRIPTION OF THE DRAWINGS

FIG. 1 is a schematic structural diagram of an electronic device provided in implementations of the present disclosure.

FIG. 2 is a schematic structural diagram of an electronic device provided in other implementations of the present disclosure.

FIG. 3 is a schematic cross-sectional structural diagram of the electronic device illustrated in FIG. 1 taken in direction P1-P1.

FIG. 4 is a schematic cross-sectional diagram of the electronic device of FIG. 2 taken in direction P2-P2.

FIG. 5 is a schematic structural diagram of a flexible screen assembly, a first driving member, and a second driving member in the electronic device illustrated in FIG. 3 in other implementations of the present disclosure.

FIG. 6 is a schematic structural diagram of a flexible screen assembly, a first driving member, and a second driving member in the electronic device illustrated in FIG. 3 in other implementations of the present disclosure.

FIG. 7 is a schematic structural diagram of a first carrier and a flexible screen assembly in the electronic device illustrated in FIG. 1.

FIG. 8 is a schematic structural diagram of the electronic device illustrated in FIG. 4 with a second driving member displaced.

FIG. 9 is an exploded schematic structural diagram of a second carrier and a flexible screen assembly in the electronic device illustrated in FIG. 3.

FIG. 10 is an enlarged schematic structural diagram of the second carrier and the flexible screen assembly at region A in FIG. 9.

FIG. 11 is a partial schematic structural diagram of an electronic device provided in implementations of the present disclosure.

FIG. 12 is a schematic structural diagram of the electronic device illustrated in FIG. 11 taken in direction P3-P3.

FIG. 13 is an enlarged schematic structural diagram of the electronic device at region B in FIG. 12.

FIG. 14 is a schematic structural diagram of the electronic device illustrated in FIG. 12 with a second driving member displaced.

FIG. 15 is an enlarged schematic structural diagram of the electronic device at region C in FIG. 14.

FIG. 16 is a schematic structural diagram of a first bracket, a second driving member, and a first elastic member in the second carrier and the flexible screen assembly illustrated in FIG. 9.

FIG. 17 is a schematic structural diagram of an electronic device provided in other implementations of the present disclosure.

FIG. 18 is a partial schematic structural diagram of an electronic device provided in implementations of the present disclosure.

FIG. 19 is a schematic structural diagram of an electronic device provided in other implementations of the present disclosure.

FIG. 20 is a schematic structural diagram of an electronic device provided in other implementations of the present disclosure.

### DETAILED DESCRIPTION

An electronic device is provided in implementations of the present disclosure. The electronic device includes a first carrier, a second carrier, a first driving member, a second driving member, and a flexible screen assembly. The second carrier is movable relative to the first carrier to make the electronic device extend. The first driving member and the second driving member each are disposed on the second carrier. The flexible screen assembly has a first end and a second end each connected with the first carrier. The flexible screen assembly is wrapped around the first driving member and the second driving member. A part of the flexible screen assembly located at the first driving member forms a first turn, and a part of the flexible screen assembly located at the second driving member forms a second turn. When the second carrier moves relative to the first carrier, the flexible screen assembly is configured to move relative to the first driving member and the second driving member. During extension of the electronic device, a part of the flexible screen assembly from the first end to the first turn becomes longer, and a part of the flexible screen assembly from the second turn to the second end becomes shorter.

In implementations of the present disclosure, the flexible screen assembly is wrapped around the first driving member and the second driving member, and two ends of the flexible screen assembly are connected with the first carrier, such that a damage to the flexible screen assembly due to forces concentrated at a certain position of the flexible screen assembly can be avoided. In addition, when the first carrier and the second carrier move relative to each other, the flexible screen assembly is driven to move relative to the first driving member and the second driving member, which can improve consistency between relative movement of the first carrier and the second carrier and movement of the flexible screen assembly relative to the first driving member and the second driving member, thereby reducing a damage to the flexible screen assembly during movement.

In an optional implementation of the present disclosure, the part of the flexible screen assembly from the first end to the first turn is parallel to the part of the flexible screen assembly from the second end to the second turn.

In an optional implementation of the present disclosure, the flexible screen assembly is wrapped around the first driving member clockwise and is wrapped around the second driving member clockwise; or the flexible screen assembly is wrapped around the first driving member clockwise and is wrapped around the second driving member counterclockwise.

In an optional implementation of the present disclosure, the first driving member and the second driving member each are rotatably connected with the second carrier, and when the flexible screen assembly moves relative to the first driving member and the second driving member, the flexible screen assembly is configured to drive the first driving member and the second driving member each to rotate relative to the second carrier.

In an optional implementation of the present disclosure, the part of the flexible screen assembly from the first end to the first turn is not parallel to the part of the flexible screen assembly from the second end to the second turn.

In an optional implementation of the present disclosure, the second end of the flexible screen assembly is connected with the first carrier through an elastic mechanism, and the elastic mechanism is elastically deformed to make a distance between the second end of the flexible screen assembly and the first carrier adjustable.

In an optional implementation of the present disclosure, the first driving member has a diameter larger than the second driving member.

In an optional implementation of the present disclosure, the flexible screen assembly includes a flexible display module and a driving belt. The flexible display module has a first end which serves as the first end of the flexible screen assembly and is connected with the first carrier, the flexible display module is wrapped around the first driving member, the flexible display module has a second end connected with a first end of the driving belt, a second end of the driving belt which serves as the second end of the flexible screen assembly is connected with the first carrier, and the driving belt is disposed around the second driving belt.

In an optional implementation of the present disclosure, the flexible screen assembly includes a flexible display module, a support member, and a driving belt. The flexible display module covers the support member. The support member is disposed around the first driving member. The support member has a first end which serves as the first end of the flexible screen assembly and is connected with the first carrier, the support member has a second end connected with a first end of the driving belt, a second end of the driving belt which serves as the second end of the flexible screen assembly is connected with the first carrier, and the driving belt is disposed around the second driving member.

In an optional implementation of the present disclosure, the electronic device further includes an adjustment mechanism. The adjustment mechanism is configured to finely adjust a distance between the first driving member and the second driving member when the flexible screen assembly is slack, to make the flexible screen assembly in a tensioned state.

In an optional implementation of the present disclosure, the second driving member is movably connected with the second carrier through a first bracket. The adjustment mechanism includes a first elastic member. The first elastic member has one end abutting against the first bracket and another end abutting against the second carrier. The first elastic member is in a compressed state to apply an elastic force to the first bracket. When the flexible screen assembly is slack, the first elastic member is elastically deformed to drive the second driving member to move in a direction away from the first driving member.

In an optical implementation of the present disclosure, an elastic deformation amount of the first elastic member is positively related to a slackness degree of the flexible screen assembly.

In an optical implementation of the present disclosure, the first driving member is fixedly connected with the second carrier.

In an optional implementation of the present disclosure, the second carrier is provided with a protrusion, the first bracket defines a through hole, the protrusion passes through the through hole, the through hole has a size larger than the protrusion, and a first movement space is defined between the first bracket and the protrusion in a movement direction of the flexible screen assembly.

In an optional implementation of the present disclosure, the first movement space is smaller than a maximum deformation amount of the first elastic member to keep the first elastic member in the compressed state.

In an optional implementation of the present disclosure, the second carrier defines an accommodating groove. The first bracket has a straight portion and a bending portion. The straight portion is sleeved on the protrusion through the through hole. The bending portion is bendably disposed relative to the straight portion, and the bending portion is located in the accommodating groove. A second movement space is defined between the bending portion and a groove wall of the accommodating groove. The first elastic member is accommodated in the accommodating groove. The first elastic member has one end abutting against the bending portion and another end abutting against the groove wall of the accommodating groove.

In an optional implementation of the present disclosure, the first driving member is movably connected with the second carrier through a second bracket. The adjustment mechanism further includes a second elastic member. The second elastic member has one end abutting against the second bracket and another end abutting against the second carrier. The second elastic member is in the compressed state to apply an elastic force to the second bracket. When the flexible screen assembly is slack, the second elastic member is elastically deformed to drive the first driving member to move in a direction away from the second driving member.

In an optional implementation of the present disclosure, the first driving member is movably connected with the second carrier through a second bracket. The second driving member is movably connected with the second carrier through a first bracket. The adjustment mechanism includes a first elastic member. The first elastic member has one end abutting against the second bracket and another end abutting against the first bracket. The first elastic member is in a compressed state to apply an elastic force to the first bracket and the second bracket. When the flexible screen assembly is slack, the first elastic member is elastically deformed to drive the first driving member to move in a direction away from the second driving member and drive the second driving member to move in a direction away from the first driving member.

In an optional implementation of the present disclosure, the first driving member is disposed at one side of the second carrier, the second driving member is disposed at an opposite side of the second carrier. The first driving member is movably connected with the second carrier through a second bracket. The second driving member is fixedly connected with the second carrier. The adjustment mechanism includes a first elastic member. The first elastic member has one end abutting against a first bracket and another end abutting against the second carrier. The first elastic member is in a compressed state to apply an elastic force to the second bracket. When the flexible screen assembly is slack, the first elastic member is elastically deformed to drive the first driving member to move in a direction away from the second driving member.

In an optional implementation of the present disclosure, the electronic device further includes a processor and a detecting mechanism. The processor is electrically coupled with the detecting mechanism and the adjustment mechanism respectively. The detecting mechanism is configured to detect a state of the flexible screen assembly. The processor is configured to control the adjustment mechanism to drive the first driving member to move in a direction away from the second driving member, and/or control the second driving member to move in a direction away from the first driving member, to increase a distance between the first driving member and the second driving member, when the flexible screen assembly is slack.

In an optical implementation of the present disclosure, the electronic device further a driving apparatus. The driving apparatus includes a driving motor and a transmission structure. The transmission structure is connected with the first carrier and/or the second carrier. The driving motor is configured to drive the transmission structure to move.

In an optical implementation of the present disclosure, the driving apparatus further includes a connecting member. The transmission structure is a transmission screw rod. The connecting member is connected with the second carrier. The connecting member is connected with the transmission screw rod.

Another electronic device is further provided in implementations of the present disclosure. The electronic device includes a first carrier, a second carrier, a first driving member, a second driving member, and a flexible screen assembly. The second carrier and the first carrier are movable relative to each other to make the electronic device extend. The first driving member and the second driving member each are disposed on the second carrier. The flexible screen assembly has a first end and a second end each connected with the first carrier. The flexible screen assembly is disposed around the first driving member and the second driving member. A projection of the second end on a plane where the first carrier is located falls between a projection of the first driving member on the plane where the first carrier is located and a projection of the second driving member on the plane where the first carrier is located.

In an optional implementation of the present disclosure, a distance between the projection of the second end on the plane where the first carrier is located and the projection of the first driving member on the plane where the first carrier is located is less than the distance between the projection of the first end on the plane where the first carrier is located and the projection of the first driving member on the plane where the first carrier is located.

Technical solutions of implementations of the present disclosure will be described clearly and completely with reference to accompanying drawings in implementations of the present disclosure below. Apparently, implementations described herein are merely some implementations, rather than all implementations, of the present disclosure. Based on implementations of the present disclosure, all other implementations obtained by those of ordinary skill in the art without creative effort shall fall within the protection scope of the present disclosure.

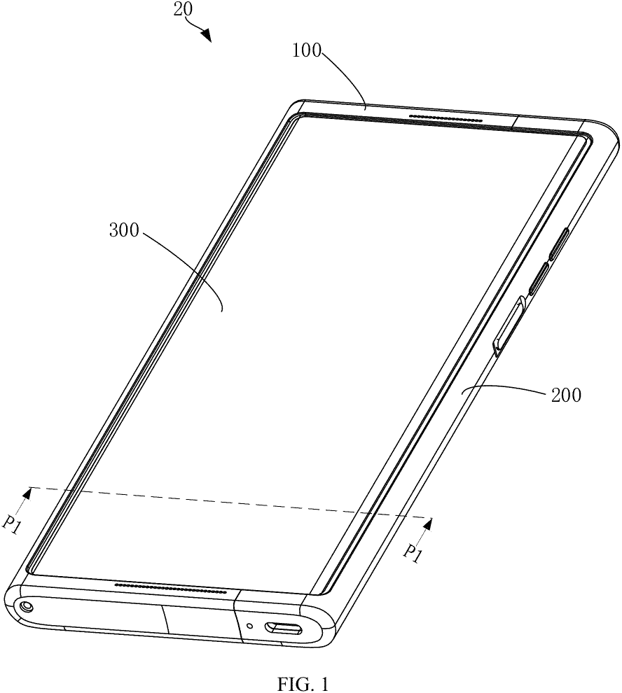

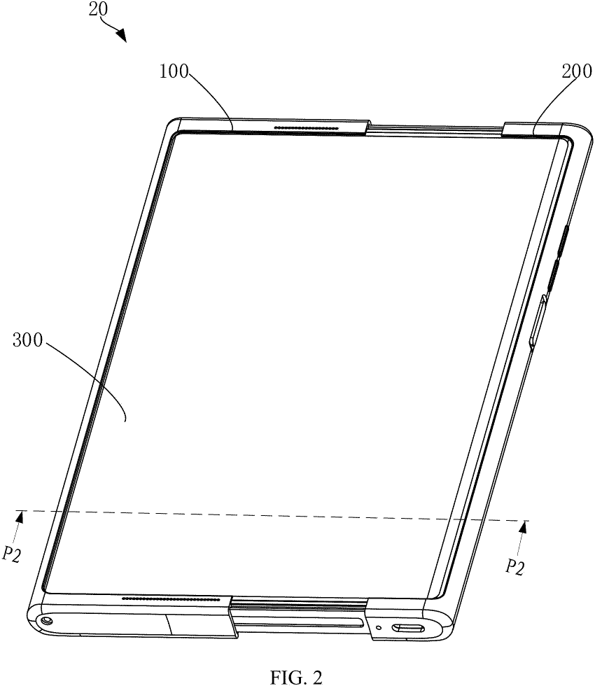

Reference can be made to FIG. 1 to FIG. 2, where FIG. 1 is a schematic structural diagram of an electronic device provided in implementations of the present disclosure, and FIG. 2 is a schematic structural diagram of an electronic device provided in other implementations of the present disclosure. An electronic device such as an electronic device 20 of FIG. 1 may be a computing device such as a laptop computer, a computer monitor containing an embedded computer, a tablet computer, a cellular telephone, a media player, or other handheld or portable electronic devices, a smaller device (e.g., such as a wrist-watch device, a pendant device, a headphone or earpiece device, a device embedded in eyeglasses or other devices worn on a user’s head, or other wearable or miniature devices), a television, a computer display without an embedded computer, a gaming device, a navigation device, an embedded system (e.g., a system, in which an electronic device with a display is mounted, in a kiosk or automobile), a device that implements the functionality of two or more of these devices, or other electronic devices. In an illustrative configuration of FIG. 1, the electronic device 20 is a portable device such as a cellular telephone, media player, tablet computer, wearable device, or other portable computing devices. Other configurations may be used for device 10 if desired. The example of FIG. 1 is merely illustrative.

The electronic device 20 may include a first carrier 100 and a second carrier 200 movable relative to each other, which can be realized by a slidable connection of the first carrier 100 and the second carrier 200. For example, the first carrier 100 defines a sliding groove, and a side edge of the second carrier 200 being located in the sliding groove and able to slide in the sliding groove. An extending state and a retracting state can be switched by relative movement of the first carrier 100 and the second carrier 200. Referring to FIG. 1, the retracting state is a state formed by relative movement of the first carrier 100 and the second carrier 200 in directions close to each other. Referring to FIG. 2, the extending state is a state formed by relative movement of the first carrier 100 and the second carrier 200 in directions away from each other.

It can be understood that in the retracting state, when the first carrier 100 and the second carrier 200 move in the directions away from each other, the second carrier 200 can move from the inside of the first carrier 100 to the outside of the first carrier 100, to switch from the retracting state to the extending state. In the extending state, when the first carrier 100 and the second carrier 200 move in the directions close to each other, the second carrier 200 may move from the outside of the first carrier 100 to the inside of the first carrier 100, to switch from the extending state to the retracting state.

It should be noted that the first carrier 100 and the second carrier 200 can have various extending states, for example, a maximum movement distance between the first carrier 100 and the second carrier 200 in the directions away from each other is H, and the first carrier 100 and the second carrier 200 can move away from each other in the retracting state to form extending states with different distances such as a quarter of H, a half of H, three quarters of H, etc. States in which the distance gradually grows can be defined as a first extending state, a second extending state, a third extending state, and the like in turn.

It should also be noted that when the first carrier 100 and the second carrier 200 are in the first extending state, for example the first carrier 100 and the second carrier 200 move away from each other by a distance of a quarter of H to be in the first extending state, the first carrier 100 and the second carrier 200 can still move away from each other to reach the second extending state, for example the first carrier 100 and the second carrier 200 move away from each other by a distance of a half of H to be in the second extending state.

It can be understood that one or more of extending states of the first carrier 100 and the second carrier 200 in implementations of the present disclosure are illustrative only, and are not intended to limit the extending states of the first carrier 100 and the second carrier 200 of the implementations of the present disclosure.

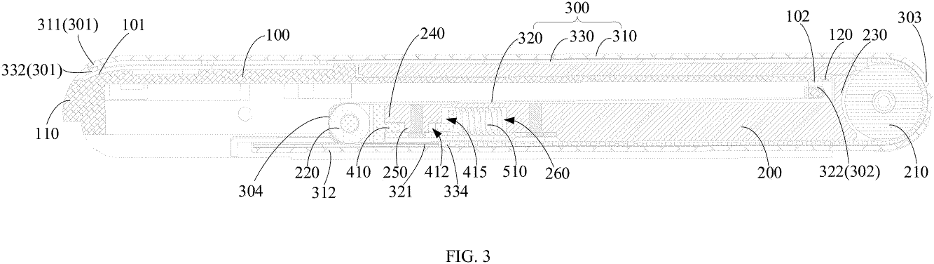

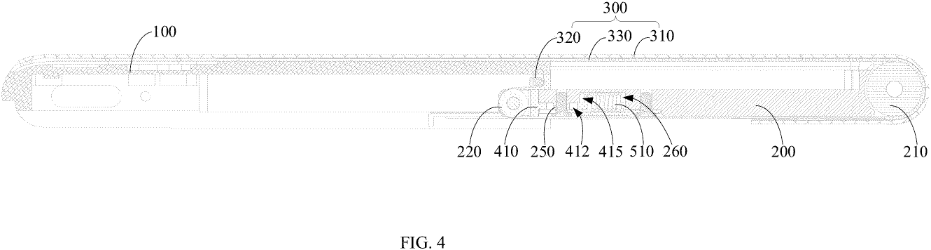

Reference can be made to FIG. 3 and FIG. 4, where FIG. 3 is a schematic cross-sectional structural diagram of the electronic device illustrated in FIG. 1 taken in direction P1-P1, and FIG. 4 is a schematic cross-sectional diagram of the electronic device of FIG. 2 taken in direction P2-P2. The second carrier 200 is connected with a first driving member 210 and a second driving member 220, and the first driving member 210 is spaced apart from the second driving member 220. It should be noted that the first driving member 210 and the second driving member 220 may be directly connected with the second carrier 200, or indirectly connected with the second carrier 200 through other components. The first driving member 210 may be in a regular shape, such as a cylinder or a semi-cylinder, or in an irregular shape, for example one surface of the first driving member 210 may be a circular arc surface, and the other surfaces may be flat surfaces or wavy surfaces. The first driving member 210 may be an additional component independent of the second carrier 200, or a part of the second carrier 200.

The second driving member 220 may have the same structure as the first driving member 210, for example, the first driving member 210 and the second driving member 220 may both have cylindrical structures. The second driving member 220 may also have a different structure from the first driving member 210.

The electronic device 20 further includes a flexible screen assembly 300. The flexible screen assembly 300 has a first end 301 and a second end 302 each connected with the first carrier 100. For example, the first end 301 of the flexible screen assembly 300 may be connected with an external surface 101 of the first carrier 100, and the second end 302 of the flexible screen assembly 300 may be connected with the first carrier 100. A projection of the second end 302 on a plane where the first carrier 100 is located falls between a projection of the first driving member 210 on the plane where the first carrier 100 is located and a projection of the second driving member 220 on the plane where the first carrier 100 is located. For example, the second end 302 of the flexible screen assembly 300 may be connected to an internal surface 102 of the first carrier 100. The external surface 101 of the first carrier 100 refers to a surface that can be seen from the outside of the first carrier 100, and the internal surface 102 of the first carrier 100 refers to a surface that is unable to be seen from the outside of the first carrier 100. In addition, the flexible screen assembly 300 is wound around the first driving member 210 and the second driving member 220.

When the first carrier 100 and the second carrier 200 are in the retracting state, the first carrier 100 and the second carrier 200 are fitted to each other. Here, an accommodation space can be defined between the first carrier 100 and the second carrier 200, and the accommodation space can be used to accommodate other components of the electronic device 20, such as a circuit board, a battery, a camera assembly, etc. A part of the flexible screen assembly 300 is also accommodated in the accommodation space. When the first carrier 100 and the second carrier 200 in the retracting state move away from each other, the first driving member 210 and the second driving member 220 can drive the flexible screen assembly 300 to move in a direction towards the outside of the accommodation space, or the outside of the electronic device 20, such that a part of the flexible screen assembly 300 originally accommodated in the accommodation space extends outside the accommodation space, or outside the electronic device 20, which makes the electronic device 20 extend and increases a display region of the electronic device 20. When the first carrier 100 and the second carrier 200 in the extending state move close to each other, the first driving member 210 and the second driving member 220 can drive the flexible screen assembly 300 to move in a direction towards the inside of the electronic device 20, such that a part of the flexible screen assembly 300 which originally extends outside the electronic device 20 retracts inside the electronic device 20, which makes the electronic device 20 restored to a traditional appearance and convenient to be carried.

In the related art, the second end of the flexible screen assembly is connected at a preset position which is between the first end of the flexible screen assembly and the second end of the flexible screen assembly, such that a part of the flexible screen assembly forms a closed-loop structure. Here, forces from multiple directions will be applied to the part of the flexible screen assembly at the preset position, such that a damage is easier to occur at the preset position than other positions. In addition, this connection manner makes assembly of the flexible screen assembly more difficult. As for two carriers being assembled first and then the two ends of the flexible screen assembly being fixed separately, during fixing, since the second end of the flexible screen assembly is directly fixed to the preset position in a form of bonding, the second end of the flexible screen assembly will be pulled when the flexible screen assembly is tensioned. After multiple movements, connection strength between the second end of the flexible screen assembly and the preset position will be reduced when the second end of the flexible screen assembly is pulled for many times. As a result, the connection strength of the second end of the flexible screen assembly and the preset position is insufficient to make the flexible screen assembly tensioned after multiple uses. As for the flexible screen assembly being bent and fixedly connected first and then the flexible screen assembly being fixed to the two carriers, if a width of a closed loop is larger than a width of a carrier to-be-mounted, the flexible screen assembly will be slack due to insufficient tension force, and if the width of the closed loop is smaller than the width of the carrier to-be-mounted, the flexible screen assembly will be damaged caused by an excessive friction force between the carrier to-be-mounted and the flexible screen assembly. It can be understood that the flexible screen assembly and the two carriers are difficult to be assembled and complicated to be disassembled in this fixing manner. In addition, tolerance between the flexible screen assembly and the two carriers is difficult to be controlled properly, which leads to problems of more tolerance accumulation and a difficulty of realizing tension of the flexible screen assembly.

In implementations of the present disclosure, the first end 301 of the flexible screen assembly 300 and the second end 302 of the flexible screen assembly 300 each are connected with the first carrier 100, such that the flexible screen assembly 300 can be mainly stressed in a movement direction of the flexible screen assembly 300 without being stressed in redundant directions, and a damage to the flexible screen assembly due to forces concentrated at a certain position of the flexible screen assembly can be avoided. In addition, two ends of the flexible screen assembly in implementations of the present disclosure each are fixed to the first carrier. During assembly, after the first end 301 of the flexible screen assembly 300 is fixed to the first carrier 100, the flexible screen assembly 300 is wrapped around the first driving member 210 and the second driving member 220 in turn, and then the second end 302 of the flexible screen assembly 300 is fixed to the first carrier 100. Therefore, the assembly manner is simple, a tension degree of the flexible screen assembly is easy to be controlled, which are easy to be implemented.

It can be seen from FIG. 3 and FIG. 4 that when the first carrier 100 and the second carrier 200 move away from each other, or when the electronic device extends, a part of the flexible screen assembly 300 from the first end 301 of the flexible screen assembly 300 to a position of the first driving member 210 becomes longer, and a part of the flexible screen assembly 300 from the second end 302 of the flexible screen assembly 300 to a position of the second driving member 220 becomes shorter. When the first carrier 100 and the second carrier 200 move close to each other, the part of the flexible screen assembly 300 from the first end 301 of the flexible screen assembly 300 to the position of the first driving member 210 becomes shorter, and the part of the flexible screen assembly 300 from the second end 302 of the flexible screen assembly 300 to the position of the second driving member 220 becomes longer. However, during relative movement of the second carrier 200 and the first carrier 100, a length of a part of the flexible screen assembly 300 from the position of the first driving member 210 to the position of the second driving member 220 is kept unchanged.

It can be understood that when the flexible screen assembly 300 is wrapped around the first driving member 210, a part of the flexible screen assembly 300 at the position of the first driving member 210 forms a first turn 303, and when the flexible screen assembly 300 is wrapped around the second driving member 220, a part of the flexible screen assembly 300 at the position of the second driving member 220 forms a second turn 304. When the second carrier 200 moves relative to the first carrier 100, the flexible screen assembly 300 moves relative to the first driving member 210 and the second driving member 220. During extension of the first carrier 100 and the second carrier 200, the part of the flexible screen assembly 300 from the first end 301 to the first turn 303 becomes longer, and the part of the flexible screen assembly 300 from the second turn 304 to the second end 302 becomes shorter. The first turn 303 refers to a part of the flexible screen assembly 300 abutting against the first driving member 210, and the second turn 304 refers to a part of the flexible screen assembly 300 abutting against the second driving member 220. The part of the flexible screen assembly 300 from the first end 301 to the first turn 303 refers to a part of the flexible screen assembly 300 from the first end 301 to any position in the first turn 303, such as a position where the first turn 303 is tangent to the first driving member 210 or a middle position in the first turn 303. The part of the flexible screen assembly 300 from the second turn 304 to the second end 302 refers to a part of the flexible screen assembly 300 from the second end 302 to any position in the second turn 304, such as a position where the second turn 304 is tangent to the second driving member 220 or a middle position in the second turn 304.

In the related art, the flexible display screen is usually fixed by fixing one end of the flexible display screen and rolling and winding the other end of the flexible display screen around a scroll. In addition, when two housings move relative to each other, the flexible display screen is released or wound by rotation of the scroll. In this way, when the two housings have started to move, the scroll may have not yet started to rotate, which results in slackness of the flexible display screen due to no support of the housings, or when the scroll has started to rotate, the two housings may have not yet started to move, which results in a damage to a flexible screen due to an excessive force on the flexible display screen. It can be understood that in the related art, relative movement of the two housings and movement of the flexible screen assembly are driven separately, such that the relative movement of the two housings and the movement of the flexible screen assembly may be not synchronized due to asynchronous driving of the relative movement of the two housings and the movement of the flexible screen assembly. However, in implementations of the present disclosure, the flexible screen assembly 300 is wrapped around the first driving member 210 and the second driving member 220. The two ends of the flexible screen assembly 300 each are connected with the first carrier 100. When the first carrier and the second carrier are driven by a driving force (which may be a force applied by manual driving or a driving force applied by electric driving) to move, the first carrier and the second carrier will drive the flexible screen assembly 300 to move together. Compared with the related art, consistency between relative movement of the two carriers and movement of the flexible screen assembly 300 can be ensured, and a damage to the flexible screen assembly 300 can be reduced during movement of the two carriers.

In addition, in a manner that the flexible display screen is rolled and wound in the related art, during winding or releasing, a difference may exist between a rolling amount and a releasing amount, which results in different overall lengths of the flexible display screen in each state, such that the flexible display screen has different flatness in each state, thereby affecting a display effect of the flexible display screen. However, in implementations of the present disclosure, a length of the flexible screen assembly 300 is kept unchanged in each state, such that during movement of the flexible screen assembly 300, or when a part of the flexible screen assembly 300 retracts inside the electronic device 20, or when a part of the flexible screen assembly 300 extends outside the electronic device 20, flatness of the flexible screen assembly 300 is kept unchanged, which can provide a better display effect for a user.

A distance between the projection of the second end 302 on the plane where the first carrier 100 is located and the projection of the first driving member 210 on the plane where the first carrier 100 is located is less than a distance between the projection of the first end 301 on the plane where the first carrier 100 is located and the projection of the first driving member 210 on the plane where the first carrier 100 is located. It can be understood that the position where the second end 302 of the flexible screen assembly 300 is connected with the first carrier 100 is close to the first driving member 210. For example, reference can continue to be made to FIG. 3 and FIG. 4, and the first carrier 100 in implementations of the present disclosure has a first side 110 and a second side 120 opposite to the first side 110. The first side 110 and the second side 120 may be two sides in a width direction F3 of the electronic device 20. The first side 110 is away from the first driving member 210 relative to the second side 120, that is, the second side 120 is closer to the first driving member 210 than the first side 110, and a projection of the second side 120 on the plane where the first carrier 100 is located falls between the projection of the first driving member 210 on the plane where the first carrier 100 is located and the projection of the second driving member 220 on the plane where the first carrier 100 is located. The first end 301 of the flexible screen assembly 300 is connected with an external surface of the first side 110, and the second end 302 of the flexible screen assembly 300 is connected with an internal surface of the second side 120. It should be noted that when the first carrier 100 includes two opposite side edges and a bearing plate, the first side 110 may include one of the two side edges and a region of the bearing plate adjacent to the side edge, and the second side 120 may include the other of the two side edges and a region of the bearing plate adjacent to the other side edge.

The second carrier 200 has a third side 230 and a fourth side 240 opposite to the third side 230. The third side 230 and the fourth side 240 are two sides in the width direction F3 of the electronic device 20. The third side 230 is disposed close to the second side 120 relative to the fourth side 240, that is, the third side 230 is a side close to the second side 120 and the fourth side 240 is a side away from the second side 120. The first driving member 210 is disposed at the third side 230 of the second carrier 200, and the second driving member 220 is disposed at the fourth side 240 of the second carrier 200. During mounting, the first end 301 of the flexible screen assembly 300 is connected with the external surface of the first side 110 first, and then the second end 302 of the flexible screen assembly 300 is connected with the internal surface of the second side 120 after the flexible screen assembly 300 is sequentially wrapped around the first driving member 210 and the second driving member 220, such that when the first carrier 100 and the second carrier 200 extend to the maximum distance, a part of the flexible screen assembly 300 can completely extend outside the electronic device 20, and when the first carrier 100 and the second carrier 200 completely retract, a part of the flexible screen assembly 300 can be completely accommodated in the electronic device 20. It can be understood that compared with disposing the first driving member 210 and the second driving member 220 at the middle of the second carrier 200, a distance difference caused by the relative movement of the first carrier 100 and the second carrier 200 can be utilized to the maximum extent by disposing the first driving member 210 and the second driving member 220 at two opposite sides of the second carrier 200.

As illustrated in FIG. 3 and FIG. 4, the part of the flexible screen assembly 300 from the first end 301 to the first turn 303 is parallel to the part of the flexible screen assembly 300 from the second turn 304 to the second end 302, such that during extension of the electronic device 20, a distance of the relative movement of the first carrier 100 and the second carrier 200 is equal to a length of the flexible screen assembly 300 extending outside the electronic device 20. For example, during the relative movement of the first carrier 100 and the second carrier 200 in implementations of the present disclosure, it is assumed that the first carrier 100 and the second carrier 200 move away from each other by a movement distance of L1, since the first driving member 210 and the second driving member 220 are connected with the second carrier 200, each of a movement distance between the first driving member 210 and the first carrier 100 and a movement distance between the second driving member 220 and the first carrier 100 is also L1. The flexible screen assembly 300 is wrapped around two driving members, and when the two driving members move, the two driving members will drive the flexible screen assembly 300 to extend together, such that the part of the flexible screen assembly 300 from the first end 301 of the flexible screen assembly 300 to the first turn 303 becomes longer, a length increased is also L1. The part of the flexible screen assembly 300 from the second end 302 of the flexible screen assembly 300 to the second turn 304 becomes shorter. Since an overall length of the flexible screen assembly 300 is unchanged when the flexible screen assembly 300 is not fatigue, and a distance between the first driving member 210 and the second driving member 220 is unchanged, a length by which the part of the flexible screen assembly 300 from the second end 302 of the flexible screen assembly 300 to the second turn 304 is shortened should also be L1. Similarly, it is assumed that the first carrier 100 and the second carrier 200 move close to each other by a movement distance of L2, a length of the part of the flexible screen assembly 300 from the first end 301 of the flexible screen assembly 300 to the first turn 303 increases by L2 compared with the length before movement, and a length of the part of the flexible screen assembly 300 from the second end 302 of the flexible screen assembly 300 to the second turn 304 decreases by L2 compared with the length before movement.

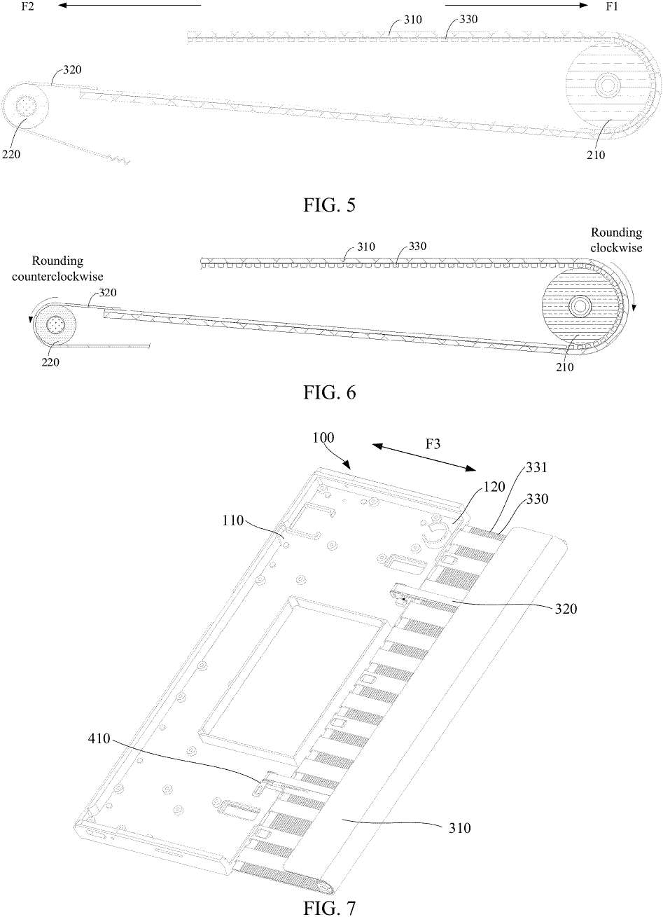

It should be noted that reference can be made to FIG. 5, which is a schematic structural diagram of a flexible screen assembly, a first driving member, and a second driving member in the electronic device illustrated in FIG. 3 in other implementations of the present disclosure. The part of the flexible screen assembly 300 from the first end 301 to the first turn 303 may also not be parallel to the part of the flexible screen assembly 300 from the second turn 304 to the second end 302. Here, since two parts are not disposed in parallel, the flexible screen assembly 300 needs to set aside a part of length to compensate for an amount of tilt caused by the two parts being not in parallel. It can be understood that during the extension of the electronic device, a length shortened of the part of the flexible screen assembly 300 from the second turn 304 to the second end 302 when the two parts are not disposed in parallel will be smaller than the length shortened of the part of the flexible screen assembly 300 from the second turn 304 to the second end 302 when the two parts are disposed in parallel, such that the length of the flexible screen assembly 300 that can extend outside the electronic device becomes shorter. In order to solve this problem, the second end 302 of the flexible screen assembly 300 can be connected with the first carrier 100 through an elastic mechanism (such as a spring), and the elastic mechanism can be elastically deformed to make the distance between the second end 302 of the flexible screen assembly 300 and the first carrier 100 adjustable, such that an elastic deformation amount of the elastic mechanism can absorb the amount of tilt caused by the part of the flexible screen assembly 300 from the first end 301 to the first turn 303 being not parallel to the part of the flexible screen assembly 300 from the second turn 304 to the second end 302.

As illustrated in FIG. 3 and FIG. 4, a direction in which the flexible screen assembly 300 is wrapped around the first driving member 210 is the same as a direction in which the flexible screen assembly 300 is wrapped around the second driving member 220. For example, the flexible screen assembly 300 may be wrapped around the first driving member 210 clockwise and the flexible screen assembly 300 may be wrapped around the second driving member 220 clockwise.

When the flexible screen assembly 300 moves, the flexible screen assembly 300 rubs against surfaces of the first driving member 210 and the second driving member 220. When a friction force is too large, movement of the flexible screen assembly 300 is impeded, which reduces smoothness of the movement of the flexible screen assembly 300 and damages the flexible screen assembly 300. In implementations of the present disclosure, in order to improve the smoothness of the movement of the flexible screen assembly 300, the first driving member 210 is configured to be rotatable relative to the second carrier 200, and the second driving member 220 is configured to be rotatable relative to the second carrier 200, where a rotation direction of the first driving member 210 is the same as a rotation direction of the second driving member 220.

For example, the second carrier 200 may be provided with a first fixed shaft at the third side 230, and the first driving member 210 may be sleeved on the first fixed shaft and rotatably connected with the first fixed shaft (for example, the first driving member 210 may be connected with the first fixed shaft through balls). The second carrier 200 may be provided with a second fixed shaft at the fourth side 240, and the second driving member 220 may be sleeved on the second fixed shaft and rotatably connected with the second fixed shaft (for example, the second driving member 220 may be connected with the second fixed shaft through balls). When the first carrier 100 and the second carrier 200 move away from each other, the first driving member 210 is configured to push the flexible screen assembly 300 to move in first direction F1. When the flexible screen assembly 300 moves, the flexible screen assembly 300 is configured to drive the first driving member 210 to rotate around the first fixed shaft counterclockwise and drive the second driving member 220 to rotate around the second fixed shaft clockwise, so as to extend a part of the flexible screen assembly 300 to the outside of the electronic device 20 to expand a display region of the flexible screen assembly 300. When the first carrier 100 and the second carrier 200 move close to each other, the second driving member 220 is configured to push the flexible screen assembly to move in second direction F2. When the flexible screen assembly 300 moves, the flexible screen assembly 300 is configured to drive the second driving member 220 to rotate around the second fixed shaft clockwise and drive the first driving member 210 to rotate around the first fixed shaft clockwise, so as to retract a part of the flexible screen assembly 300 to the inside of the electronic device 20, thereby reducing the display region of the flexible screen assembly 300 and reducing an overall size of the electronic device 20. Compared with the first driving member 210 and second driving member 220 each being fixed, the first driving member 210 and the second driving member 220 in implementations of the present disclosure can rotate relative to the second carrier 200, which can reduce a movement friction force between the flexible screen assembly 300 and each of the first driving member 210 and the second driving member 220 during the movement of the flexible screen assembly 300, improve the smoothness of the movement of the flexible screen assembly 300, and reduce a damage to the flexible screen assembly 300.

It should be noted that an arrangement manner of the flexible screen assembly 300 is not limited to this. For example, reference can be made to FIG. 6, which is a schematic structural diagram of a flexible screen assembly, a first driving member, and a second driving member in the electronic device illustrated in FIG. 3 in other implementations of the present disclosure. A direction in which the flexible screen assembly 300 is wrapped around the first driving member 210 is opposite to a direction in which the flexible screen assembly 300 is wrapped around the second driving member 220. For example, the flexible screen assembly 300 may be wrapped around the first driving member 210 clockwise and the flexible screen assembly 300 may be wrapped around the second driving member 220 counterclockwise. The first driving member 210 and the second driving member 220 may also rotate relative to the second carrier 200, and a rotation direction of the first driving member 210 is different from a rotation direction of the second driving member 220. For example, when the first carrier 100 moves away from the second carrier 200, the first driving member 210 is configured to push the flexible screen assembly 300 to move in first direction F1. When the flexible screen assembly 300 moves, the flexible screen assembly 300 is configured to drive the first driving member 210 to rotate around the first fixed shaft counterclockwise and drive the second driving member 220 to rotate around the second fixed shaft clockwise, so as to extend a part of the flexible screen assembly 300 to the outside of the electronic device 20 to expand a display region of the flexible screen assembly 300. When the first carrier 100 and the second carrier 200 move close to each other, the second driving member 220 is configured to push the flexible screen assembly to move in second direction F2. When the flexible screen assembly 300 moves, the flexible screen assembly 300 is configured to drive the second driving member 220 to rotate around the second fixed shaft counterclockwise and drive the first driving member 210 to rotate around the first fixed shaft clockwise, so as to retract a part of the flexible screen assembly 300 to the inside of the electronic device 20, thereby reducing the display region of the flexible screen assembly 300 and reducing the overall size of the electronic device 20.

As illustrated in FIG. 3 to FIG. 6, the first driving member 210 and the second driving member 220 in implementations of the present disclosure each have a cylindrical structure, and the first driving member 210 has a radius larger than the second driving member 220. Compared with setting a radius of the second driving member 220 to be the same as or larger than the radius of the first driving member 210, by setting a size of the second driving member 220 in the electronic device 20 to be smaller than a size of the first driving member 210, it is possible to save an internal space of the electronic device 20 occupied by the second driving member 220.

Reference can continue to be made to FIG. 3 and FIG. 4, and during the movement of the flexible screen assembly 300, a part of the flexible screen assembly 300 is always accommodated in the electronic device 20. In order to simplify a structure of the flexible screen assembly 300, the part of the flexible screen assembly 300 accommodated in the electronic device 20 may be configured as a part for no picture display, or may be configured as a part without a flexible display module. For example, the flexible screen assembly 300 may include a flexible display module 310 and a driving belt 320. The flexible display module 310 has a first end 311 connected with the external surface 101 of the first carrier 100, the flexible display module 310 has a second end 312 connected with a first end 321 of the driving belt 320, and the flexible display module 310 is wrapped around the first driving member 210. The first end 311 of the flexible display module 310 serves as the first end 301 of the flexible screen assembly 300. A second end 322 of the driving belt 320 is connected to the internal surface 102 of the first carrier 100, and the driving belt 320 is wrapped around the second driving member 220. The second end 322 of the driving belt 320 serves as the second end 302 of the flexible screen assembly 300.

When the first carrier 100 and the second carrier 200 move away from each other, the first driving member 210 is configured to push the flexible display module 310 to move in first direction F1 and drive the driving belt 320 to move in first direction F1, such that a first part of the flexible display module 310 extends outside the electronic device 20 to display a picture together with a second part of the flexible display module 310. A display content of the first part of the flexible display module 310 may be the same as or different from a display content of the second part of the flexible display module 310. Here, the driving belt 320 is accommodated in the electronic device 20, and a distance between the first end 321 of the driving belt 320 and the second driving member 220 is larger than a distance between the second end 322 of the driving belt 320 and the second driving member 220. When the first carrier 100 and the second carrier 200 move close to each other, the second driving member 220 is configured to push the driving belt 320 to move in second direction F2 and drive the flexible display module 310 to move in second direction F2, such that the first part of the flexible display module 310 retracts inside the electronic device 20, and only the second part of the flexible display module 310 is exposed beyond the electronic device 20. Here, the driving belt 320 is still accommodated in the electronic device 20, and the distance between the first end 321 of the driving belt 320 and the second driving member 220 is smaller than the distance between the second end 322 of the driving belt 320 and the second driving member 220.

When the first part of the flexible display module 310 retracts inside the electronic device 20, the electronic device 20 may control the first part of the flexible display module 310 to be in a sleep state to save power, or control the first part of the flexible display module 310 to be in an operating state to meet other requirements of a user.

Reference can be made to FIG. 7, which is a schematic structural diagram of a first carrier and a flexible screen assembly in the electronic device illustrated in FIG. 1. The flexible display module 310 is provided with a support member 330 at a non-display surface. The support member 330 can support the flexible display module 310 to improve flatness of the flexible display module 310, and can also separate the flexible display module 310 from other components to protect the flexible display module 310. The first end 321 of the driving belt 320 is connected with a second end 333 of the support member 330. A first end 332 of the support member 330 is connected with the first carrier 100. The first end 332 of the support member 330 serves as the first end 301 of the flexible screen assembly 300. Compared with a connection between the driving belt 320 and the flexible display module 310, the flexible display module 310 can be prevented from being directly subjected to a pulling force of the driving belt 320 through a connection between the driving belt 320 and the support member 330, and the flexible display module 310 can be further protected. A part of the support member 330 that is located on the non-display surface of the first part of the flexible display module 310 may include multiple support bars 331 arranged at intervals, and two adjacent support bars 331 are connected with each other. Compared with a plate-like support structure, this structure where the multiple support bars 331 are arranged at intervals and two adjacent support bars 331 are connected with each other, can make the part of the support member 330 that is located on the non-display surface of the first part of the flexible display module 310 easy to be bent, so as to reduce a difficulty of disposing the support member 330 around the first driving member 210, or improve fit of the support member 330 wrapped around the first driving member 210. A structure of the part of the support member 330 that is located on the non-display surface of the second part of the flexible display module 310 may be the same as or different from a structure of the part that is located on a non-display surface of the first part of the flexible display module 310. For example, the part of the support member 330 that is located on the non-display surface of the second part of the flexible display module 310 may has a plate-like structure.

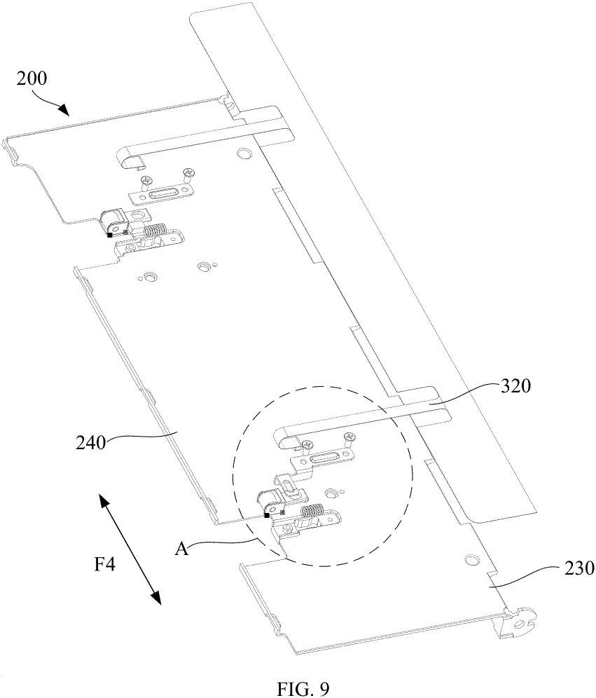

The number of the second driving member 220 may be one or more. For example, as illustrated in FIG. 9, the number of the second driving member 220 is two, and two second driving members 220 are arranged at an interval, for example one second driving member 220 and the other second driving member 220 are respectively disposed close to two opposite ends of the second carrier 200 in a length direction F4 of the electronic device 20. The length direction F4 of the electronic device 20 is perpendicular to the width direction F3 of the electronic device 20. Here, the number of the driving belt 320 may be two, one driving belt 320 is wrapped around one second driving member 220, and two second driving members 220 are connected with the second end 312 of the flexible display module 310 together, such that when the first carrier 100 and the second carrier 200 move close to each other, the first carrier 100 and the second carrier 200 pull the flexible display module 310 to move in second direction F2 together. Therefore, the flexible display module 310 is more stable during the movement of the flexible display module 310, and the flexible display module 310 is avoided from being damaged due to deflection of the flexible display module 310 during the movement of the flexible display module 310.

The flexible screen assembly 300 is usually made of a flexible material, which may have a decreased stress value after multiple movements, resulting in slackness of the flexible screen assembly 300. In order to solve the above problems, the second carrier 200 in implementations of the present disclosure is configured to be movably connected with the first driving member 210 and/or the second driving member 220, and an adjustment mechanism is additionally disposed. The adjustment mechanism can be used to adjust a relative position between the second carrier 200 and at least one of the first driving member 210 or the second driving member 220, so as to increase a distance between the first driving member and the second driving member, such that a tension value of the flexible screen assembly 300 is within a preset range, thereby ensuring that the flexible screen assembly 300 is kept flat under tension.

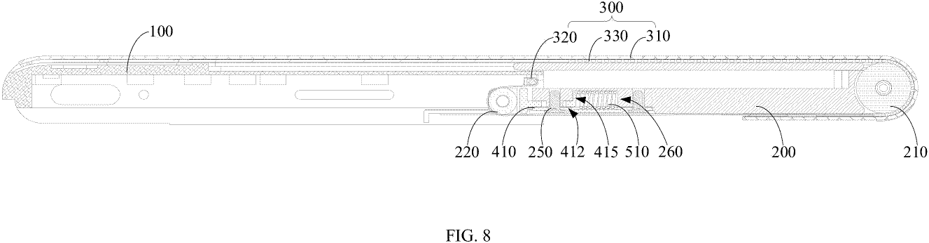

For example, reference can be made to FIG. 4 and FIG. 8 together, where FIG. 8 is a schematic structural diagram of the electronic device illustrated in FIG. 4 with a second driving member displaced in. In implementations of the present disclosure, the second carrier 200 can be movably connected with the second driving member 220 through a first bracket 410, and a first elastic member 510 is additionally disposed between the first driving member 210 and the second driving member 220. The first elastic member 510 has one end abutting against the first bracket 410, and the first elastic member 510 has the other end abutting against the second carrier 200. The first elastic member 510 can be elastically deformed to drive the first bracket 410 to move in a direction away from the first driving member 210, thereby increasing a distance between the first driving member 210 and the second driving member 220.

The first elastic member 510 may be a compression spring or other elastically deformable device, and a maximum deformation amount of the first elastic member 510 is positively related to a slackness degree of the flexible screen assembly 300. It can be understood that the maximum deformation amount of the first elastic member 510 is set according to the slackness degree of the flexible screen assembly 300. When the flexible screen assembly 300 is slacker, the maximum deformation amount of the first elastic member 510 becomes larger. For example, a test can be performed according to usage of the flexible screen assembly 300 to obtain the slackness degree of the flexible screen assembly 300 during service life of the flexible screen assembly 300, in other words, how much the maximum slackness amount of the flexible screen assembly 300 can reach. Then the maximum deformation amount of the first elastic member 510 is set according to the maximum slackness amount of the flexible screen assembly 300, such that the maximum deformation amount of the first elastic member 510 is sufficient to absorb the maximum slackness of the flexible screen assembly 300.

It can be understood that when the flexible screen assembly 300 is slack, the first elastic member 510 is configured to push the first bracket 410 to move to increase the distance between the first driving member 210 and the second driving member 220, thereby offsetting a length variation of the flexible screen assembly 300 caused by the decreased stress value, such that a current tension value of the flexible screen assembly 300 is restored to be within the preset range and then the flatness of the flexible screen assembly 300 is ensured.

In addition, the elastic mechanism in implementations of the present disclosure cannot only absorb a slackness amount of the flexible screen assembly 300 after multiple movements of the flexible screen assembly 300, but also absorb a slackness amount caused by improper mounting of the flexible screen assembly 300. It can be understood that when the flexible screen assembly 300 is mounted, the flexible screen assembly 300 mounted may not meet the requirement that the current tension value is within the preset range. Here, the first elastic member 510 can drive the first bracket 410 to move to increase the distance between the first driving member 210 and the second driving member 220, thereby absorbing the slackness amount of the flexible screen assembly 300 due to improper mounting. It can also be understood that a mounting difficulty of the flexible screen assembly 300 can be reduced due to arrangement of the first elastic member 510. In other words, due to the arrangement of the first elastic member 510, an elastic force of the first elastic member 510 can keep a stress value of the flexible screen assembly 300 within the preset range, regardless of slackness of the flexible screen assembly 300 caused by any reason.

It can be understood that in an initial state (such as a state after the whole device is mounted), the first elastic member 510 is compressed. It is assumed that the first elastic member 510 has a compression length of x, and the flexible screen assembly 300 has a slackness length of h. Here, the first elastic member 510 can be elastically deformed, the first bracket 410 is driven to move under the elastic force of the first elastic member 510, and the second driving member 220 is driven to move in the direction away from the first driving member 210. Since the second driving member 220 is limited by the flexible screen assembly 300, a distance that the second driving member 220 can move is equal to or slightly larger than slackness length h of the flexible screen assembly 300. When the second driving member 220 moves, the first elastic member 510 can absorb the slackness length of the flexible screen assembly 300, such that the stress value of the flexible screen assembly 300 is restored to be within the preset range. Here, the compression length of the first elastic member 510 is equal to or slightly smaller than x-h, and at the same time, the first elastic member 510 continues to maintain elasticity, so as to absorb the slackness amount caused by the decreased stress value and slackness of the flexible screen assembly 300.

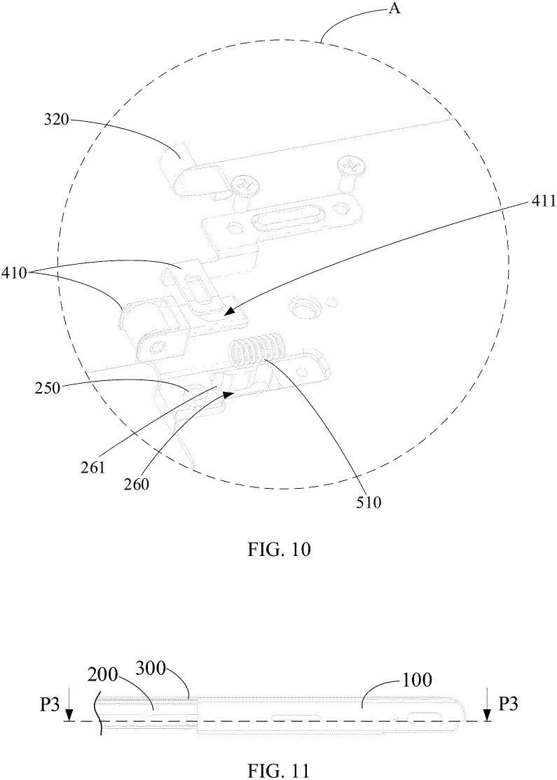

Reference can continue to be made to FIG. 9 and FIG. 10, where FIG. 9 is an exploded schematic structural diagram of a second carrier and a flexible screen assembly in the electronic device illustrated in FIG. 3, and FIG. 10 is an enlarged schematic structural diagram of the second carrier and the flexible screen assembly at region A in FIG. 9. The second carrier 200 is provided with a protrusion 250, and the first bracket 410 defines a through hole 411. The first bracket 410 is sleeved on the protrusion 250 through the through hole 411, or the protrusion 250 passes through the through hole 411. The through hole 411 has a size larger than the protrusion 250 in the movement direction of the flexible screen assembly 300, such that a first movement space 412 is defined between the first bracket 410 and the protrusion 250.

The first movement space 412 is smaller than the maximum deformation amount when the first elastic member 510 is elastically deformed, so as to ensure that the first elastic member 510 is always in a compressed state under an abutting force of the first bracket 410 and an abutting force of the second carrier 200, such that the first elastic member 510 in the compressed state always has an elastic force on the first bracket 410, to make the stress value of the flexible screen assembly 300 always within the preset range. It can be understood that when the first movement space 412 is too large, the first elastic member 510 may fail to abut between the second carrier 200 and the first bracket 410 after being completely released, such that the elastic force of the first elastic member 510 on the first bracket 410 decreases or disappears, resulting in a slack or wrinkled flexible screen assembly 300.

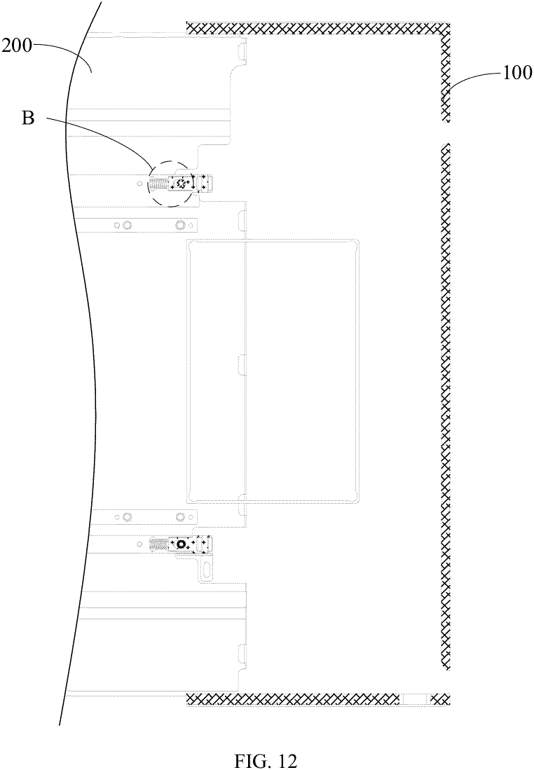

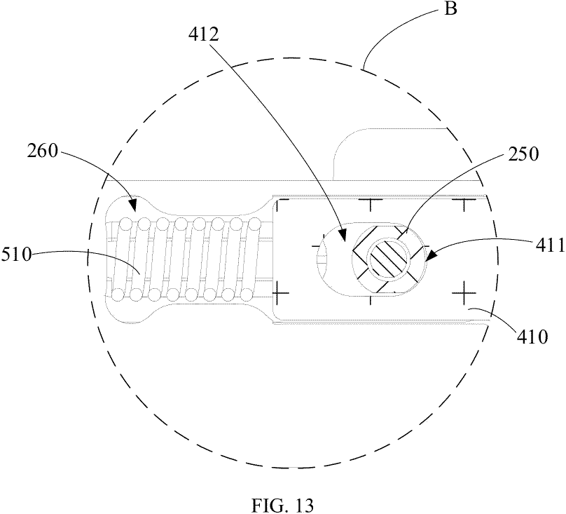

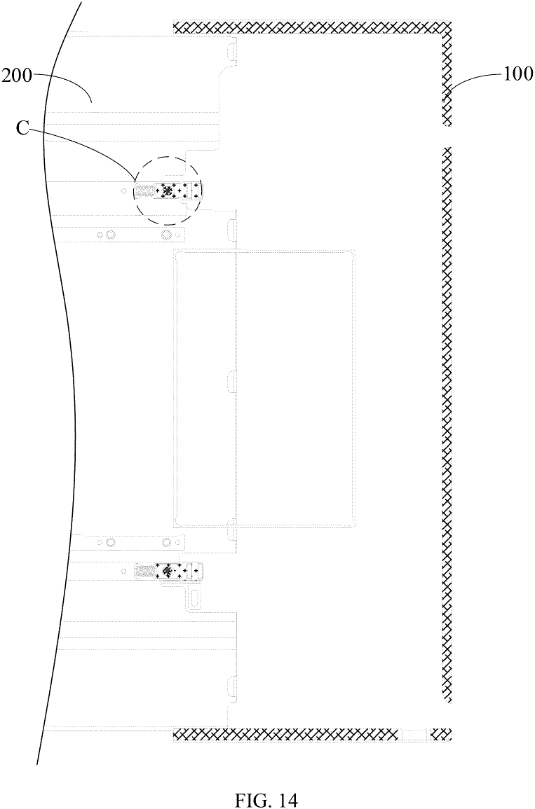

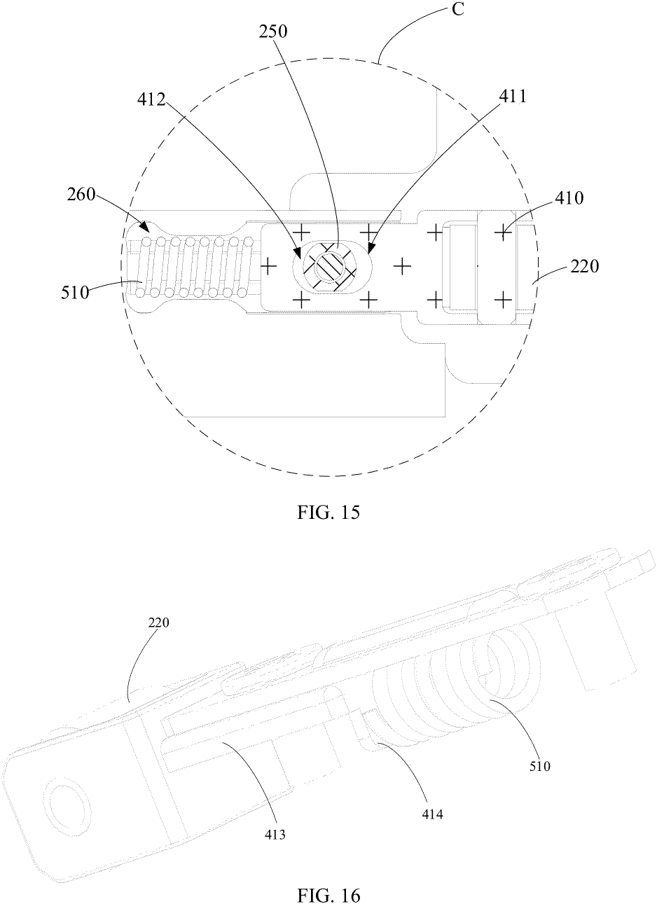

Reference can be made to FIG. 11 to FIG. 15 together, where FIG. 11 is a partial schematic structural diagram of an electronic device provided in implementations of the present disclosure, FIG. 12 is a schematic structural diagram of the electronic device illustrated in FIG. 11 taken in direction P3-P3, FIG. 13 is an enlarged schematic structural diagram of the electronic device at region B in FIG. 12, FIG. 14 is a schematic structural diagram of the electronic device illustrated in FIG. 12 with a second driving member displaced, and FIG. 15 is an enlarged schematic structural diagram of the electronic device at region C in FIG. 14. A movement process of the second driving member 220 is described below with reference to the accompanying drawings. In the initial state (such as the state after the whole device is mounted), the first elastic member 510 is compressed, and the first bracket 410 is in a first position relative to the protrusion 250. When the flexible screen assembly 300 is slack, the first elastic member 510 is elastically deformed to apply an elastic force to the first bracket 410. The first bracket 410 moves within the first movement space 412 under the elastic force of the first elastic member 510, such that the first bracket 410 moves to a second position relative to the protrusion 250. When the first bracket 410 moves, the first bracket 410 is configured to drive the second driving member 220 to move in the direction away from the first driving member 210 to increase the distance between the first driving member 210 and the second driving member 220, and absorbs the slackness amount of the flexible screen assembly 300. In order to make the first bracket 410 move in a preset direction without deflection, the through hole 411 in implementations of the present disclosure has a strip-shaped structure and abuts with the protrusion 250 in all directions except the movement direction of the flexible screen assembly 300, so as to limit the movement direction of the first bracket 410, such that the first bracket 410 moves in the movement direction of the flexible screen assembly 300, and the flatness of the flexible screen assembly 300 can be prevent from being affected due to the deflection of the first bracket 410 when the first bracket 410 moves.

Reference can be made to FIG. 4, FIG. 10, FIG. 13, and FIG. 16, where FIG. 16 is a schematic structural diagram of a first bracket, a second driving member, and a first elastic member in the second carrier and the flexible screen assembly illustrated in FIG. 9. In implementations of the present disclosure, the second carrier 200 defines an accommodating groove 260, and the accommodating groove 260 can be used to accommodate the first elastic member 510 and a part of the first bracket 410 which abuts against the first elastic member 510. For example, the second carrier 200 has a bottom wall and a side wall, and the side wall is wrapped around a periphery of the bottom wall to define the accommodating groove 260. The first bracket 410 has a straight portion 413 and a bending portion 414, the through hole 411 is defined at the straight portion 413, and the bending portion 414 is bendably disposed relative to the straight portion 413. The bending portion 414 is located in the accommodating groove 260, and a second movement space 415 is defined between the bending portion 414 and a groove wall (or a side wall) 261 of the accommodating groove 260. The first elastic member 510 is accommodated in the accommodating groove 260, one end of the first elastic member 510 abuts against the bending portion 414, and the other end of the first elastic member 510 abuts against the groove wall (or the side wall) 261 of the accommodating groove 260. When the flexible screen assembly 300 is slack, the first elastic member 510 is elastically deformed, so as to push the bending portion 414 to compress the second movement space 415. Here, the straight portion 413 moves in the first movement space 412, such that a relative position between the first bracket 410 and the second carrier 200 is changed, the distance between the first driving member 210 and the second driving member 220 is increased, and the slackness amount of the flexible screen assembly 300 is absorbed.

The first elastic member 510 in implementations of the present disclosure is disposed on the second carrier 200, and compared with the first elastic member 510 being disposed on the first carrier, a space occupied by the first carrier 100 can be reduced, such that more devices can be disposed on the first carrier 100.

It should be noted that when the second driving member 220 is movably connected with the second carrier 200, the first driving member 210 may be fixedly connected with the second carrier 200, or be movably connected with the second carrier 200. For example, the first driving member 210 can be movably connected with the second carrier 200 through a second bracket, one end of the first elastic member 510 abuts against the first bracket 410, and the other end of the first elastic member 510 abuts against the second bracket. The first elastic member 510 is elastically deformed to drive the first bracket 410 to move in the direction away from the first driving member 210 and drive the second bracket to move in a direction away from the second driving member 220, thereby increasing the distance between the first driving member 210 and the second driving member 220. The second bracket has the same structure as the first bracket, which will not be repeated here. The second bracket may also have a different structure from the first bracket 410, as long as the second bracket is movable.

For another example, the adjustment mechanism can further include a second elastic member. The first driving member 210 can be movably connected with the second carrier 200 through the second bracket, one end of the second elastic member abuts against the second bracket, and the other end of the second elastic member abuts against the second carrier 200. The second elastic member is elastically deformed to drive the second bracket to move in the direction away from the second driving member 220. The second elastic member may have the same structure as the first elastic member and have the same connection relationships with other components as the first elastic member, which will not be repeated here. It should be noted that the second elastic member may also have a different structure from the first elastic member and have different connection relationships with other components from the first elastic member.

It should also be noted that a structure of the adjustment mechanism is not limited to this. For example, the adjustment mechanism may also include only the second elastic member. For example, the first driving member 210 is movably connected with the second carrier 200 through the second bracket, and the second driving member 220 is fixedly connected with the second carrier 200. The second elastic member is elastically deformed to drive the first driving member 210 to move in the direction away from the second driving member 220, so as to increase the distance between the first driving member 210 and the second driving member 220.

In implementations of the present disclosure, the adjustment mechanism can also be used to automatically adjust the distance between the first driving member 210 and the second driving member 220 according to the current tension value of the flexible screen assembly 300, such that the tension value of the flexible screen assembly 300 is within the preset range. It can be understood that when the tension value of the flexible screen assembly 300 is too great, the flexible screen assembly 300 may be broken, and when the tension value of the flexible screen assembly 300 is too little, the flexible screen assembly 300 may be wrinkled. The preset range may be a range preset according to characteristics of the flexible screen assembly 300, such that when the tension value of the flexible screen assembly 300 is within the preset range, the flexible screen assembly 300 can neither be broken nor wrinkled.

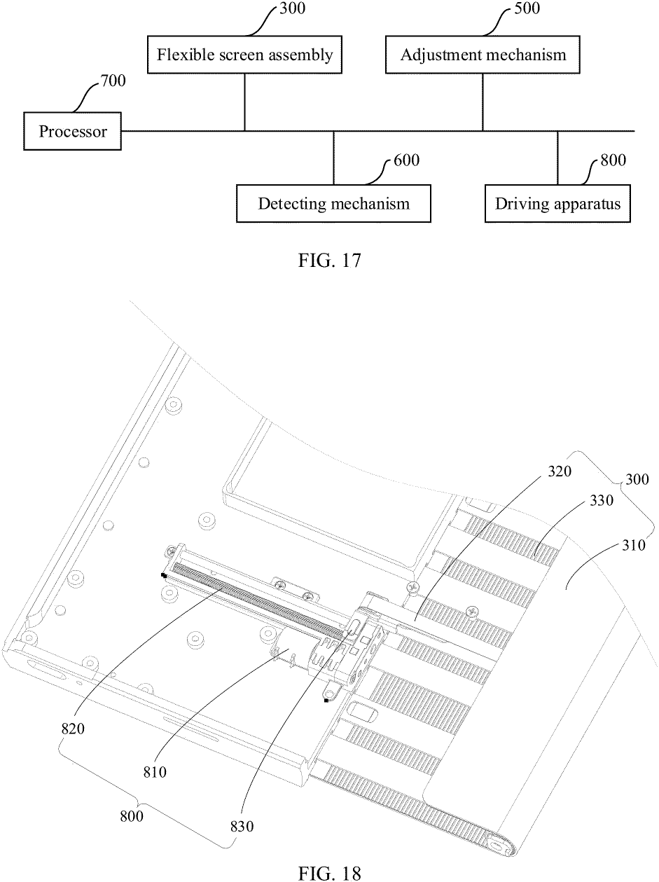

For example, reference can be made to FIG. 17, where FIG. 17 is a schematic structural diagram of an electronic device provided in other implementations of the present disclosure. The first driving member 210 can be movably connected with the second carrier 200 through a first movement structure. The electronic device 20 can be provided with a detecting mechanism 600, and a processor 700 of the electronic device 20 can be connected with the detecting mechanism 600 and the adjustment mechanism 500 respectively. The current tension value of the flexible screen assembly 300 is detected by the detecting mechanism 600, and then a detection result is fed back to the processor 700. For example, the detecting mechanism 600 may be a tension sensor. When the current tension value of the flexible screen assembly 300 is less than the minimum value within the preset range, the processor 700 can control the adjustment mechanism 500 to drive the first movement structure to move in the direction away from the second driving member 220, so as to increase the distance between the first driving member 210 and the second driving member 220, and then absorb the length variation of the flexible screen assembly 300 caused by an insufficient tension value, such that the tension value of the flexible screen assembly 300 is within the preset range. When the current tension value of the flexible screen assembly 300 is greater than the maximum value within the preset range, the processor 700 can control the adjustment mechanism 500 to drive the first movement structure to move in a direction close to the second driving member 220, so as to reduce the distance between the first driving member 210 and the second driving member 220, and then relieve a situation that the flexible screen assembly 300 is too tight due to an excessive tension value of the flexible screen assembly 300, such that the tension value of the flexible screen assembly 300 is within the preset range.

For another example, the second driving member 220 can be movably connected with the second carrier 200 through a second movement structure. When the current tension value of the flexible screen assembly 300 is less than the minimum value within the preset range, the processor 700 can control the adjustment mechanism 500 to drive the second movement structure to move in the direction away from the first driving member 210, so as to increase the distance between the first driving member 210 and the second driving member 220, such that the tension value of the flexible screen assembly 300 is within the preset range. When the current tension value of the flexible screen assembly 300 is greater than the maximum value within the preset range, the processor 700 can control the adjustment mechanism 500 to drive the second movement structure to move in a direction close to the first driving member 210, so as to reduce the distance between the first driving member 210 and the second driving member 220, such that the tension value of the flexible screen assembly 300 is within the preset range.

The first driving member 210 and the second driving member 220 both can be movably connected with the second carrier 200, and the processor 700 can control the adjustment mechanism 500 to drive the first driving member 210 and the second driving member 220 to move simultaneously to increase or decrease the distance between the first driving member 210 and the second driving member 220.

In this scheme, by using the adjustment mechanism, the first driving member and the second driving member with an unchanged relative position, and the flexible screen assembly, not only can the display region of the electronic device 20 be adjustable, but also the flatness of the flexible screen assembly 300 can be ensured in various states.

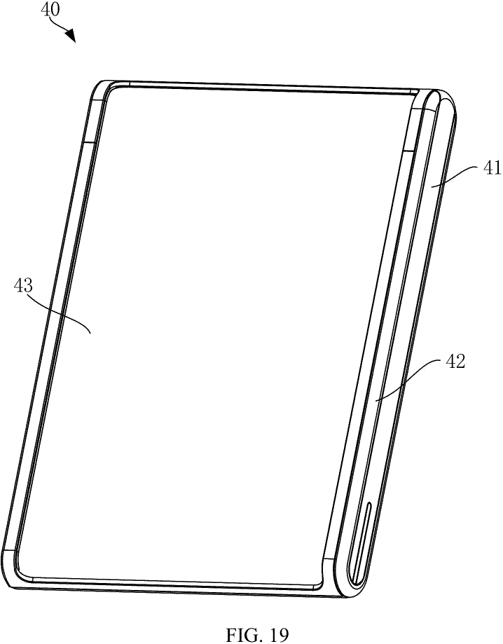

In implementations of the present disclosure, the relative movement between the first carrier 100 and the second carrier 200 can be realized by manual driving, for example, the first carrier 100 and the second carrier 200 can be pulled by two hands of a user to move relative to each other. The relative movement between the first carrier 100 and the second carrier 200 can also be realized by electric driving. The electronic device 20 can be further provided with a driving apparatus 800, and the driving apparatus 800 is configured to drive the second carrier 200 to move relative to the first carrier 100. The driving apparatus 800 may include a driving motor (or an electric motor) and a transmission structure, the transmission structure is connected with the first carrier 100 and/or the second carrier 200 in a transmission manner, and the driving motor is configured to drive the transmission structure to move. When the transmission structure moves, the transmission structure can drive the first carrier 100 and/or the second carrier 200 to move together to realize the relative movement of the first carrier 100 and the second carrier 200. The transmission structure may be a transmission screw rod or a transmission gear. For example, reference can be made to FIG. 18, which is a partial schematic structural diagram of an electronic device provided in implementations of the present disclosure, and the driving apparatus 800 may include a driving motor 810, a transmission screw rod 820, and a connecting member 830. The connecting member 830 is connected with the transmission screw rod 820 in a transmission manner, and the driving motor 810 is configured to drive the transmission screw rod 820 to rotate to drive the connecting member 830 to move. When the connecting member 830 moves, the connecting member 830 is configured to drive the second carrier 200 to move.

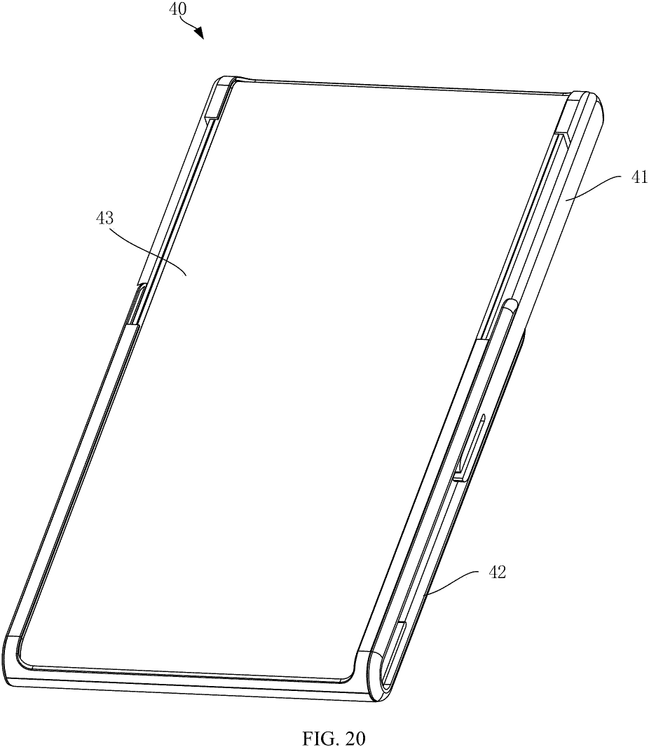

It should be noted that a pulling manner of the electronic device 20 is not limited to this. For example, reference can be made to FIG. 19 and FIG. 20, where FIG. 19 is a schematic structural diagram of an electronic device provided in other implementations of the present disclosure, and FIG. 20 is a schematic structural diagram of an electronic device provided in other implementations of the present disclosure. The pulling manner of an electronic device such as an electronic device 40 provided in implementations of the present disclosure may be longitudinal pulling. The electronic device 40 may include a first carrier 41, a second carrier 42, and a flexible screen assembly 43. The first carrier 41 and the second carrier 42 can be used to carry the electronic device 40. The first carrier 41 and the second carrier 42 can move relative to each other, such that a part of the flexible screen assembly 43 extends outside or retracts inside the electronic device 40. Longitudinal pulling refers to a manner of pulling in a direction perpendicular to a display direction of the flexible screen assembly 43.

The electronic device provided in implementations of the present disclosure are introduced in detail in the foregoing, and specific examples are applied herein to set forth the principle and implementations of the present disclosure, and the foregoing illustration of implementations is only to help in understanding the present disclosure. Meanwhile, those of ordinarily skill in the art may make variations and modifications to the present disclosure in terms of the specific implementations and application scopes according to the ideas of the present disclosure. Therefore, the specification shall not be construed as limitations to the present disclosure.

What is claimed is:

1. An electronic device, comprising:
a first carrier;
a second carrier movable relative to the first carrier;
a first driving member and a second driving member each disposed on the second carrier; and
a flexible screen assembly, having a first end and a second end each connected with the first carrier, and wrapped around the first driving member and the second driving member, wherein a part of the flexible screen assembly located at the first driving member forms a first turn, and a part of the flexible screen assembly located at the second driving member forms a second turn;
wherein the flexible screen assembly is configured to move relative to the first driving member and the second driving member when the second carrier moves relative to the first carrier, and during extension of the electronic device, a part of the flexible screen assembly from the first end to the first turn becomes longer, and a part of the flexible screen assembly from the second turn to the second end becomes shorter.

2. The electronic device of claim 1, wherein the part of the flexible screen assembly from the first end to the first turn is parallel to the part of the flexible screen assembly from the second end to the second turn.

3. The electronic device of claim 1, wherein the flexible screen assembly is wrapped around the first driving member clockwise.

4. The electronic device of claim 3, wherein the first driving member and the second driving member each are rotatably connected with the second carrier.

5. The electronic device of claim 1, wherein the part of the flexible screen assembly from the first end to the first turn is not parallel to the part of the flexible screen assembly from the second end to the second turn.

6. The electronic device of claim 1, wherein the first driving member has a diameter larger than the second driving member.

7. The electronic device of claim 1, wherein the flexible screen assembly comprises a flexible display module and a driving belt, the flexible display module has a first end which serves as the first end of the flexible screen assembly and is connected with the first carrier, the flexible display module is wrapped around the first driving member, the flexible display module has a second end connected with a first end of the driving belt, wherein a second end of the driving belt which serves as the second end of the flexible screen assembly is connected with the first carrier, and the driving belt is wrapped around the second driving belt.

8. The electronic device of claim 1, wherein the flexible screen assembly comprises a flexible display module, a support member, and a driving belt, the flexible display module covers the support member, the support member is wrapped around the first driving member, the support member has a first end which serves as the first end of the flexible screen assembly and is connected with the first carrier, the support member has a second end connected with a first end of the driving belt, wherein a second end of the driving belt which serves as the second end of the flexible screen assembly is connected with the first carrier, and the driving belt is wrapped around the second driving member.

9. The electronic device of claim 1, further comprising an adjustment mechanism, the adjustment mechanism being configured to adjust a distance between the first driving member and the second driving member when the flexible screen assembly is slack, to make the flexible screen assembly in a tensioned state.

10. The electronic device of claim 9, wherein the second driving member is movably connected with the second carrier through a first bracket, the adjustment mechanism comprises a first elastic member, the first elastic member has one end abutting against the first bracket and another end abutting against the second carrier, and the first elastic member is in a compressed state to apply an elastic force to the first bracket; and
the first elastic member is elastically deformed to drive the second driving member to move in a direction away from the first driving member, when the flexible screen assembly is slack.

11. The electronic device of claim 10, wherein an elastic deformation amount of the first elastic member is positively related to a slackness degree of the flexible screen assembly.

12. The electronic device of claim 10, wherein the first driving member is fixedly connected with the second carrier.

13. The electronic device of claim 10, wherein the second carrier is provided with a protrusion, the first bracket defines a through hole, the protrusion passes through the through hole, the through hole has a size larger than the protrusion, and a first movement space is defined between the first bracket and the protrusion in a movement direction of the flexible screen assembly.

14. The electronic device of claim 13, wherein the first movement space is smaller than a maximum deformation amount of the first elastic member to keep the first elastic member in the compressed state.

15. The electronic device of claim 13, the second carrier defines an accommodating groove, the first bracket has a straight portion and a bending portion, the straight portion is sleeved on the protrusion through the through hole, the bending portion is bendably disposed relative to the straight portion, the bending portion is located in the accommodating groove, a second movement space is defined between the bending portion and a groove wall of the accommodating groove, the first elastic member is accommodated in the accommodating groove, and the first elastic member has one end abutting against the bending portion and another end abutting against the groove wall of the accommodating groove.

16. The electronic device of claim 9, further comprising a processor and a detecting mechanism, wherein the processor is electrically coupled with the detecting mechanism and the adjustment mechanism respectively, the detecting mechanism being configured to detect a state of the flexible screen assembly, and the processor is configured to:
control the adjustment mechanism to drive the first driving member to move in a direction away from the second driving member, and/or control the second driving member to move in a direction away from the first driving member, to increase the distance between the first driving member and the second driving member, when the flexible screen assembly is slack.

17. The electronic device of claim 16, further comprising a driving apparatus, wherein the driving apparatus comprises a driving motor and a transmission structure, the transmission structure being connected with the first carrier and/or the second carrier, and the driving motor being configured to drive the transmission structure to move.

18. The electronic device of claim 17, wherein the driving apparatus further comprises a connecting member, the connecting member being connected with the second carrier, the transmission structure is a transmission screw rod, and the connecting member being connected with the transmission screw rod.

19. An electronic device, comprising:
a first carrier and a second carrier movable relative to each other to make the electronic device extend;
a first driving member and a second driving member each disposed on the second carrier; and
a flexible screen assembly, wherein the flexible screen assembly has a first end and a second end each connected with the first carrier, the flexible screen assembly is wrapped around the first driving member and the second driving member, and a projection of the second end on a plane where the first carrier is located falls between a projection of the first driving member on the plane where the first carrier is located and a projection of the second driving member on the plane where the first carrier is located.

20. The electronic device of claim 19, wherein a distance between the projection of the second end on the plane where the first carrier is located and the projection of the first driving member on the plane where the first carrier is located is less than the distance between the projection of the first end on the plane where the first carrier is located and the projection of the first driving member on the plane where the first carrier is located.
